(19) United States
(12) Patent Application Publication
(10) Pub. No.: US 2024/0096318 A1
(43) Pub. Date: Mar. 21, 2024

(54) METHODS, SYSTEMS, AND MEDIA FOR PROVIDING AUTOMATED ASSISTANCE DURING A VIDEO RECORDING SESSION

(71) Applicant: Google LLC, Mountain View, CA (US)

(72) Inventors: Trond Wuellner, Mountain View, CA (US); Ariel Braunstein, San Francisco, CA (US)

(21) Appl. No.: 17/947,381

(22) Filed: Sep. 19, 2022

(51) Int. Cl. G10L 15/22; G06F 3/01; H04N 5/765

(52) U.S. Cl. CPC G10L 15/22; G06F 3/017; H04N 5/765; G10L 2015/223

(57) ABSTRACT

Methods, systems, and media for providing automated assistance during a video recording session are provided. In some embodiments, the method comprises: receiving, at a first user device, user input to initiate a video recording session, wherein a video recording session comprises a plurality of segments of recorded video, wherein at least one segment of recorded video is non-contiguous with a second segment of recorded video; executing a machine learning model on the first user device that monitors the video recording session and that analyzes audio content and video content of the recorded video to determine segment metadata and segment quality metrics for each segment of the plurality of segments of recorded video; associating each segment of the plurality of segments of recorded video with the segment metadata and the segment quality metrics determined using the machine learning model, wherein the segment metadata and the segment quality metrics for each segment of the plurality of segments is presented when editing the recorded video from the video recording session; receiving a remote input during the video recording session, wherein the remote input comprises at least one of a voice command, a gesture command, and a remote control command; determining, using the machine learning model executing on the first user device, a video recording command associated with the remote input; and causing the video recording session to execute an action associated with the video recording command.

### TECHNICAL FIELD

The disclosed subject matter relates to methods, systems, and media for providing automated assistance during a video recording session.

### BACKGROUND

Many services, such as media sharing services and social media services, allow a user to share video content uploaded from the user's devices to the user's page or channel. Users who upload self-made videos to such services are often performing many or all of the tasks associated with video production and editing, such as writing a script, setting up appropriate lighting and props, editing and other post-production work, in addition to appearing on-camera. This can be a time consuming procedure for the user. As the user's page or channel gains a larger audience, the user often transitions into producing higher quality content, thereby requiring additional time to be spent on these video editing tasks.

It can be challenging, however, for a single person or a small team to cover all of the aspects of video production and editing in a timely manner so as to regularly produce video content for the audience. For example, a video recording session can include multiple takes of the same portion of a script, and the person who appears on camera or performs voice-over for imagery can perform the script differently in each take. In order to choose the best take, the user generally has to watch and listen to all of the takes, and use their best judgment as to which take to include in the final video. Such an example is just one of many video production tasks that can easily become unmanageable for a single user or small team of users who create and upload video content.

Accordingly, it is desirable to provide new mechanisms for providing automated assistance during a video recording session.

### SUMMARY

Methods, systems, and media for providing automated assistance during a video recording session are provided.

In accordance with some embodiments of the disclosed subject matter, a method for providing automated assistance during a video recording session is provided, the method comprising: receiving, at a first user device, user input to initiate a video recording session, wherein a video recording session comprises a plurality of segments of recorded video, wherein at least one segment of recorded video is non-contiguous with a second segment of recorded video; executing a machine learning model on the first user device that monitors the video recording session and that analyzes audio content and video content of the recorded video to determine segment metadata and segment quality metrics for each segment of the plurality of segments of recorded video; associating each segment of the plurality of segments of recorded video with the segment metadata and the segment quality metrics determined using the machine learning model, wherein the segment metadata and the segment quality metrics for each segment of the plurality of segments is presented when editing the recorded video from the video recording session; receiving a remote input during the video recording session, wherein the remote input comprises at least one of a voice command, a gesture command, and a remote control command; determining, using the machine learning model executing on the first user device, a video recording command associated with the remote input; and causing the video recording session to execute an action associated with the video recording command.

In some embodiments, the method further comprises: receiving a request to pair a second user device with the video recording session; causing the second user device to join the video recording session by pairing the second user device with the first user device; and causing the video segment to be displayed on the second user device concurrently with the segment metadata and the segment quality metrics, wherein the segment metadata and the segment quality metrics are updated while recording the video segment.

In some embodiments, at least one of the segment metadata and the segment quality metrics indicates a first timestamp and a second timestamp and further indicates that video content between the first timestamp and the second timestamp is a particular type of video content from a plurality of types of video content.

In some embodiments, the remote input further comprises a wake word occurring before at least one of the voice command, the gesture command, and the remote command.

In some embodiments, the method further comprises: receiving a request to pair the first media device to each media device in a plurality of media devices, wherein each of the media devices comprises a video input, wherein each video input has a particular field of view; causing each media device in the plurality of devices to join the video recording session by pairing with the first user device, wherein pairing with the first user device causes video recording determined at the first media device to additionally be executed at each of the plurality of media devices; initiating a video recording segment in response to a first remote input received at the first media device; recording a full scene video segment, wherein a full scene video segment comprises a plurality of video segments, wherein each video segment in the plurality of video segments is recorded synchronously at each media device, and wherein each video segment includes an indication of which media device in the plurality of media devices was used to record each video segment; causing the video recording segment to stop being recorded in response to a second remote input received at the first media device; and causing each media device to upload the video segment recorded at the media device to a server associated with the first media device, wherein the server combines the plurality of video segments into the full scene video segment.

In some embodiments, a first subset of segments in the full scene video segment are combined by the first user device to create a second field of view, wherein the second field of view is larger than each of the particular field of view for each segment used in the first subset.

In some embodiments, the method further comprises: identifying, using the full scene video segment, a target object and a background; identifying a starting frame and an ending frame from the full scene video segment, where the target object is positioned in a first portion of the background in the starting frame and in a second portion of the background in the ending frame; determining a second subset of segments in the full scene video segment that shows the target object moving from the first portion of the background to the second portion of the background, and wherein the target object remains approximately centered in each frame of the second subset of segments; and combining the second subset of segments into a first duration of video footage.

In some embodiments, the target object comprises a plurality of persons, and the method further comprises: identifying, for each person in the plurality of persons, a particular starting frame and a particular ending frame from the full scene video segment where the person is positioned in a particular first portion of the background in the starting frame and in a particular second portion of the background in the ending frame; determining, for each person in the plurality of persons, a particular subset of segments in the full scene video segment that shows the person moving from the particular first portion of the background to the particular second portion of the background, and wherein the person remains approximately centered in each frame of the particular subset of segments; and combining, for each person in the plurality of persons, the particular subset of segments into a particular duration of video footage.

In accordance with some embodiments of the disclosed subject matter, a system for providing automated assistance during a video recording session is provided, the system comprising: a memory; and a hardware processor that is configured to: receive, at a first user device, user input to initiate a video recording session, wherein a video recording session comprises a plurality of segments of recorded video, wherein at least one segment of recorded video is non-contiguous with a second segment of recorded video; execute a machine learning model on the first user device that monitors the video recording session and that analyzes audio content and video content of the recorded video to determine segment metadata and segment quality metrics for each segment of the plurality of segments of recorded video; associate each segment of the plurality of segments of recorded video with the segment metadata and the segment quality metrics determined using the machine learning model, wherein the segment metadata and the segment quality metrics for each segment of the plurality of segments is presented when editing the recorded video from the video recording session; receive a remote input during the video recording session, wherein the remote input comprises at least one of a voice command, a gesture command, and a remote control command; determine, using the machine learning model executing on the first user device, a video recording command associated with the remote input; and cause the video recording session to execute an action associated with the video recording command.

In accordance with some embodiments of the disclosed subject matter, a non-transitory computer-readable medium containing computer executable instructions that, when executed by a processor, cause the processor to execute a method for providing automated assistance during a video recording session is provided, the method comprising: receiving, at a first user device, user input to initiate a video recording session, wherein a video recording session comprises a plurality of segments of recorded video, wherein at least one segment of recorded video is non-contiguous with a second segment of recorded video; executing a machine learning model on the first user device that monitors the video recording session and that analyzes audio content and video content of the recorded video to determine segment metadata and segment quality metrics for each segment of the plurality of segments of recorded video; associating each segment of the plurality of segments of recorded video with the segment metadata and the segment quality metrics determined using the machine learning model, wherein the segment metadata and the segment quality metrics for each segment of the plurality of segments is presented when editing the recorded video from the video recording session; receiving a remote input during the video recording session, wherein the remote input comprises at least one of a voice command, a gesture command, and a remote control command; determining, using the machine learning model executing on the first user device, a video recording command associated with the remote input; and causing the video recording session to execute an action associated with the video recording command.

In accordance with some embodiments of the disclosed subject matter, a system for providing automated assistance during a video recording session is provided, the system comprising: means for receiving, at a first user device, user input to initiate a video recording session, wherein a video recording session comprises a plurality of segments of recorded video, wherein at least one segment of recorded video is non-contiguous with a second segment of recorded video; means for executing a machine learning model on the first user device that monitors the video recording session and that analyzes audio content and video content of the recorded video to determine segment metadata and segment quality metrics for each segment of the plurality of segments of recorded video; means for associating each segment of the plurality of segments of recorded video with the segment metadata and the segment quality metrics determined using the machine learning model, wherein the segment metadata and the segment quality metrics for each segment of the plurality of segments is presented when editing the recorded video from the video recording session; means for receiving a remote input during the video recording session, wherein the remote input comprises at least one of a voice command, a gesture command, and a remote control command; means for determining, using the machine learning model executing on the first user device, a video recording command associated with the remote input; and means for causing the video recording session to execute an action associated with the video recording command.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example block diagram of a system that can be used to implement mechanisms described herein for providing automated assistance during a video recording session in accordance with some embodiments of the disclosed subject matter.

FIG. 2 shows an example block diagram of hardware that can be used in a server and/or a user device of FIG. 1 for providing automated assistance during a video recording session in accordance with some embodiments of the disclosed subject matter.

FIG. 3 shows an example flow diagram of an illustrative process for providing automated assistance during a video recording session in which a video recording command is executed in accordance with some embodiments of the disclosed subject matter.

FIG. 4 shows an example flow diagram of an illustrative process for providing automated assistance during a video recording session in accordance with some embodiments of the disclosed subject matter.

FIG. 5 shows an example flow diagram of an illustrative process for providing automated assistance during a video recording session in accordance with some embodiments of the disclosed subject matter.

FIGS. 6A and 6B show examples of audio and visual cues that can be used for providing automated assistance during a video recording session in accordance with some embodiments of the disclosed subject matter.

FIG. 7 shows an example of a video recording session using automated assistance in accordance with some embodiments of the disclosed subject matter.

FIG. 8 shows an example of a display screen used for providing automated assistance during a video recording session in accordance with some embodiments of the disclosed subject matter.

### DETAILED DESCRIPTION

In accordance with various embodiments of the disclosed subject matter, mechanisms (which can include methods, systems, and media) for providing automated assistance during a video recording session are provided. More particularly, the mechanisms relate to using machine learning models to automatically provide feedback to a user who is recording video content, such that the user can capture video content while also performing video editing tasks (either with or without automated assistance), such as trimming shots, deleting outtakes, evaluating lighting quality of a scene, etc.

Creating video content for public consumption on a social media and/or other sharing website can be a fulfilling experience for many users. However, as there are many aspects to producing high-quality video content, the number of decisions and tasks involved in producing a final video can present a challenge to users who are reliant on themselves (or a small team) to produce videos. The mechanisms described herein can allow a user to start and stop a recording remotely, and can automatically provide feedback on aspects of video quality during the recording or capture process.

In some embodiments, the mechanisms can begin when a user opens a video recording application on a user device. In some embodiments, opening the video recording application can initiate a video recording session on the user device, which can, for example, allow a user to perform voice commands that the user device can respond to. That is, a video recording session includes running the video camera(s) (or any suitable video capturing device) and/or microphone(s) (or any suitable audio capturing device) on the user device to listen and/or watch for voice and/or gesture commands when the device is not actively recording a video segment to a video file.

In some embodiments, the mechanisms can determine a video recording command from any suitable input that was remotely sent to the user device. For example, in some embodiments, a remote input of a voice command can be determined by the mechanisms to contain a video recording command that causes the user device to begin recording. In another example, a remote input of a hand gesture can be determined by the mechanisms to contain a portion of metadata indicating the scene number for the video, and the mechanisms can then cause the user device to add the scene number to the video segment metadata.

In some embodiments, a user can pair a second display device with the recording session. In some embodiments, a user can send the live video feed and/or any other suitable display information (such as video statistics and/or metadata) to the second display device. In some embodiments, the mechanisms can automatically determine information, such as metadata, and can compute statistics and/or metrics on a video segment while the video segment is being recorded. For example, in some embodiments, the mechanisms can process the audio feed in real time to measure speaking patterns of the user. In another example, in some embodiments, the mechanisms can process the images in the video frames in real time to track facial expressions, eye movements, detect additional gestures, etc.

In some embodiments, a user can pair a second or any number of additional devices having cameras and/or microphones with the recording session. In some embodiments, the mechanisms can cause any video recording commands received as remote input at the user device to be executed on the additional devices. For example, a user can have three user devices setup at three different camera angles, with the user device hosting the video recording session positioned in front of the user. Continuing this example, when the user uses a voice command to instruct the user device to begin recording a video segment, the mechanisms can cause the two additional user devices to begin recording in synchronization with the user device. In some embodiments, the mechanisms can record additional metadata associated with the additional user devices, such that the video feeds from each device can be played back synchronously.

In some embodiments, the mechanisms can save the video footage recorded during the video recording session to a local storage, and/or to a cloud storage location. For example, in some embodiments, a user can select individual portions of video footage for upload to a cloud storage location, and can select additional portions (e.g., different takes of the same scene) to be deleted.

In some embodiments, the mechanisms can include creating composite video segments. For example, in some embodiments, the mechanisms can include using all available camera angles to track a user in a video scene. In this example, in some embodiments, the mechanisms can select video frames from different video feeds corresponding to different camera angles such that the user appears approximately in the center of the selected video frames. In some embodiments, the mechanisms can track multiple users in a similar manner.

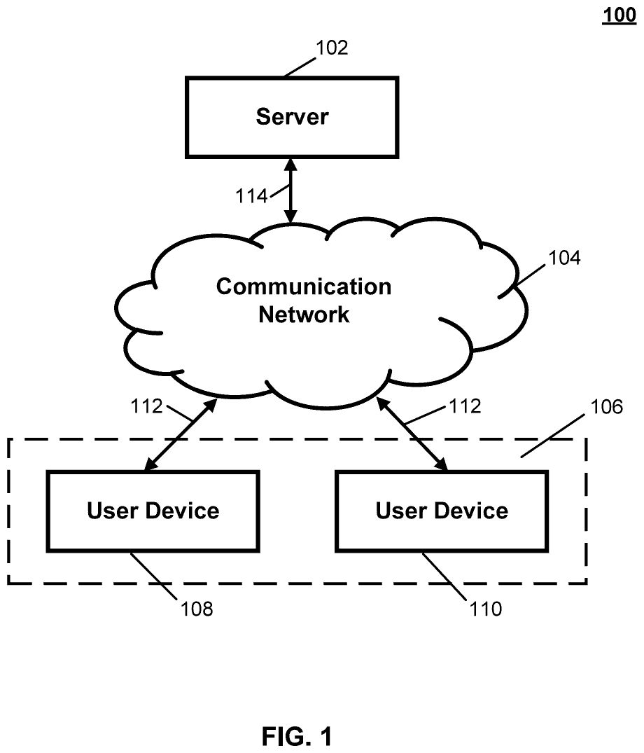

Turning to FIG. 1, an example 100 of hardware for displaying streaming media content on a user device in accordance with some embodiments is shown. As illustrated, hardware 100 can include a server 102, a communication network 104, and/or one or more user devices 106, such as user devices 108 and 110.

Server 102 can be any suitable server(s) for storing information, data, programs, media content, and/or any other suitable content. In some embodiments, server 102 can perform any suitable function(s).

Communication network 104 can be any suitable combination of one or more wired and/or wireless networks in some embodiments. For example, communication network can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 106 can be connected by one or more communications links (e.g., communications links 112) to communication network 104 that can be linked via one or more communications links (e.g., communications links 114) to server 102. The communications links can be any communications links suitable for communicating data among user devices 106 and server 102 such as network links, dial-up links, wireless links, hard-wired links, any other suitable communications links, or any suitable combination of such links.

User devices 106 can include any one or more user devices suitable for use with processes 300, 400, and 500. In some embodiments, user device 106 can include any suitable type of user device, such as speakers (with or without voice assistants), mobile phones, tablet computers, wearable computers, laptop computers, desktop computers, smart televisions, media players, game consoles, vehicle information and/or entertainment systems, and/or any other suitable type of user device.

Although server 102 is illustrated as one device, the functions performed by server 102 can be performed using any suitable number of devices in some embodiments. For example, in some embodiments, multiple devices can be used to implement the functions performed by server 102.

Although two user devices 108 and 110 are shown in FIG. 1 to avoid overcomplicating the figure, any suitable number of user devices, (including only one user device) and/or any suitable types of user devices, can be used in some embodiments.

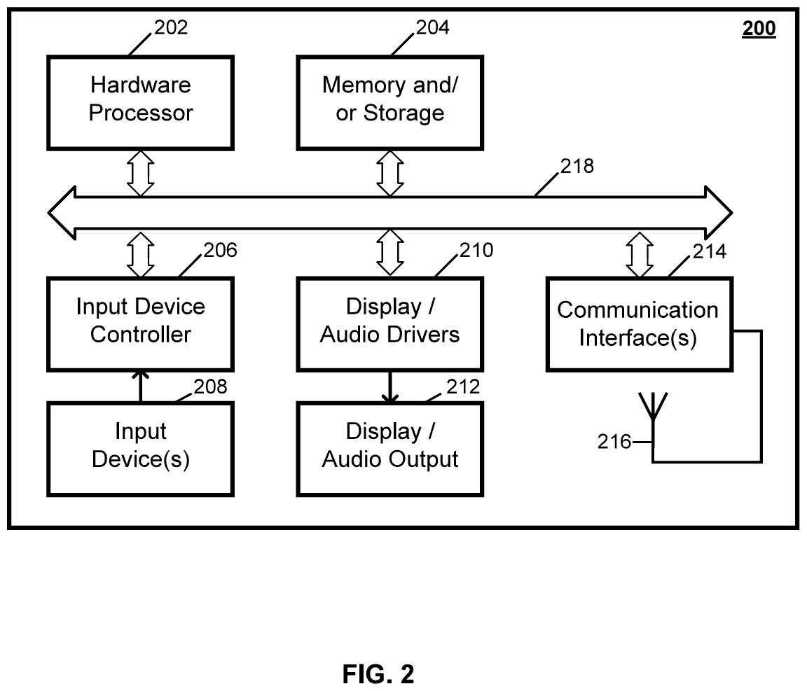

Server 102 and user devices 106 can be implemented using any suitable hardware in some embodiments. For example, in some embodiments, devices 102 and 106 can be implemented using any suitable general-purpose computer or special-purpose computer and can include any suitable hardware. For example, as illustrated in example hardware 200 of FIG. 2, such hardware can include hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 202 can be controlled by a computer program stored in memory and/or storage 204. For example, in some embodiments, the computer program can cause hardware processor 202 to perform functions described herein.

Memory and/or storage 204 can be any suitable memory and/or storage for storing programs, data, documents, and/or any other suitable information in some embodiments. For example, memory and/or storage 204 can include random access memory, read-only memory, flash memory, hard disk storage, optical media, and/or any other suitable memory.

Input device controller 206 can be any suitable circuitry for controlling and receiving input from one or more input devices 208 in some embodiments. For example, input device controller 206 can be circuitry for receiving input from a touchscreen, from a keyboard, from a mouse, from one or more buttons, from a voice recognition circuit, from one or more microphones, from a camera, from an optical sensor, from an accelerometer, from a temperature sensor, from a near field sensor, and/or any other type of input device.

Display/audio drivers 210 can be any suitable circuitry for controlling and driving output to one or more display/audio output devices 212 in some embodiments. For example, display/audio drivers 210 can be circuitry for driving a touchscreen, a flat-panel display, a cathode ray tube display, a projector, a speaker or speakers, and/or any other suitable display and/or presentation devices.

Communication interface(s) 214 can be any suitable circuitry for interfacing with one or more communication networks, such as network 104 as shown in FIG. 1. For example, interface(s) 214 can include network interface card circuitry, wireless communication circuitry, and/or any other suitable type of communication network circuitry.

Antenna 216 can be any suitable one or more antennas for wirelessly communicating with a communication network (e.g., communication network 104) in some embodiments. In some embodiments, antenna 216 can be omitted.

Bus 218 can be any suitable mechanism for communicating between two or more components 202, 204, 206, 210, and 214 in some embodiments.

Any other suitable components can be included in hardware 200 in accordance with some embodiments. For example, in some embodiments, memory and/or storage 204 can include programs, data, documents, and/or any other suitable information for recording audio data and/or video data from input device controller 206. For example, programs stored in memory and/or storage 204 can, when executed by hardware processor 202, cause input device controller 206 to begin recording audio and/or video from input device(s) 208, such as a microphone and a camera (e.g., a camera having multiple lenses), respectively. In another example, in some embodiments, programs stored in memory and/or storage 202 can, when executed by hardware processor 202, cause input device controller 206 to stop recording, pause recording, and/or perform any other suitable actions related to video and/or audio capture.

In another example, memory and/or storage 204 can include programs, data, documents, and/or any other suitable information to apply a machine learning model to video and/or audio data. For example, memory and/or storage 204 can include training data, such as video clips, audio clips, image files, and/or text files that can be used to train a machine learning model to recognize input voice commands and/or gestures. In another example, memory and/or storage 204 can include a trained machine learning model (e.g., artificial neural networks such as a deep learning neural networks, Bayesian networks, support vector machines, classifiers of any type, or any other suitable statistical or heuristic machine learning system types). The machine learning models may be implemented using any suitable type of learning, including, for example, supervised or unsupervised online learning or offline learning.

In some embodiments, a trained machine learning model can be trained on any suitable corpus, such as prior content that the current user (or any other user) has made, and/or any other suitable user-created videos. In some embodiments, the trained machine learning model can take real-time video and/or audio (e.g., from input device controller 206) as input and can output classifications for audio segments, classifications for video segments, facial recognition characteristics (e.g., point-cloud maps of a recognized face, pixel coordinates and/or sentiment labels for an identified facial expression, etc.).

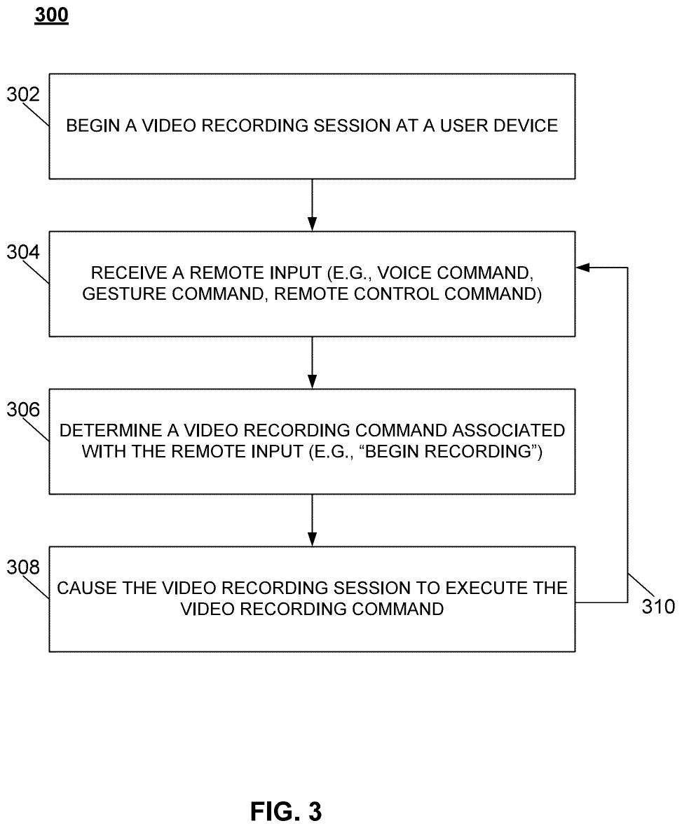

Turning to FIG. 3, an illustrative example 300 of a process for providing automated assistance during a video recording session is shown in accordance with some embodiments of the disclosed subject matter. In some embodiments, process 300 can be executed by user device 108. In some embodiments, process 300 can begin at any suitable time. For example, in some embodiments, process 300 can begin when a user opens an application on user device 108 which contains program instructions to execute process 300.

In some embodiments, as shown in FIG. 3 at 302, process 300 can begin a video recording session on a user device, such as user device 108. In some embodiments, a video recording session can include using a camera, a microphone, and/or any other suitable hardware to capture and/or record audio-visual content. In some embodiments, a video recording session can include several scenes and/or individual video shots, and each scene can be recorded several times in an individual “take.” In some embodiments, a video recording session can include the user device operating a camera and microphone (both on the user device), but not actively recording at the user device, for example, while a user is performing pre-recording tasks such as final setup of the scene, and/or adjustments. In a particular example, a user can initiate the video recording session at the user device by opening an application using a touchscreen of the user device, and can walk away from the user device to a pre-set mark where the user will sit, stand, etc., during the recording.

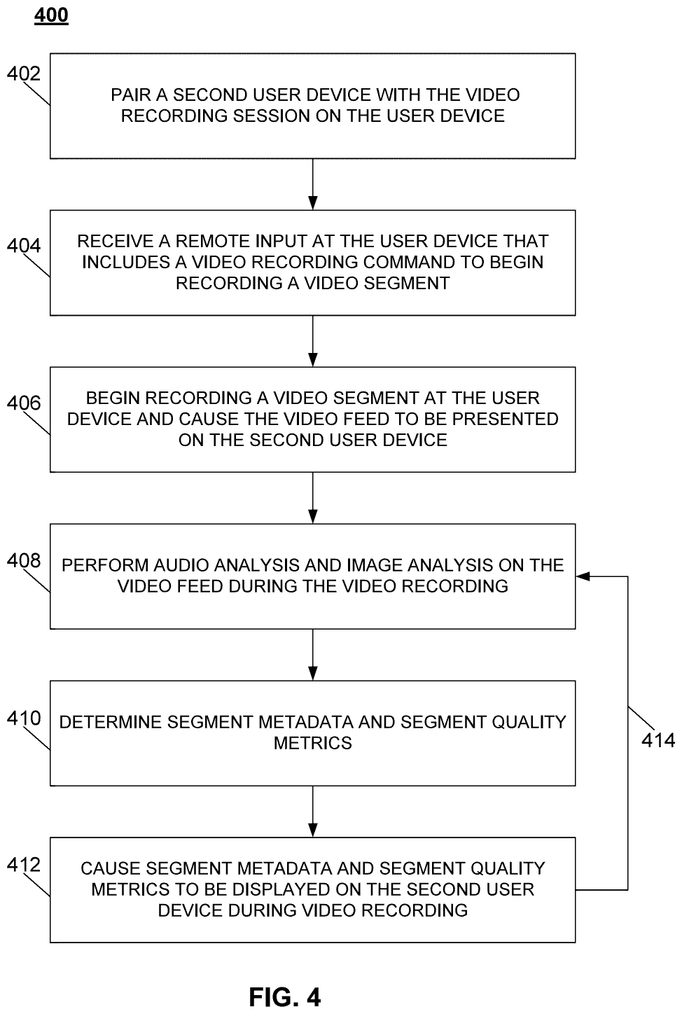

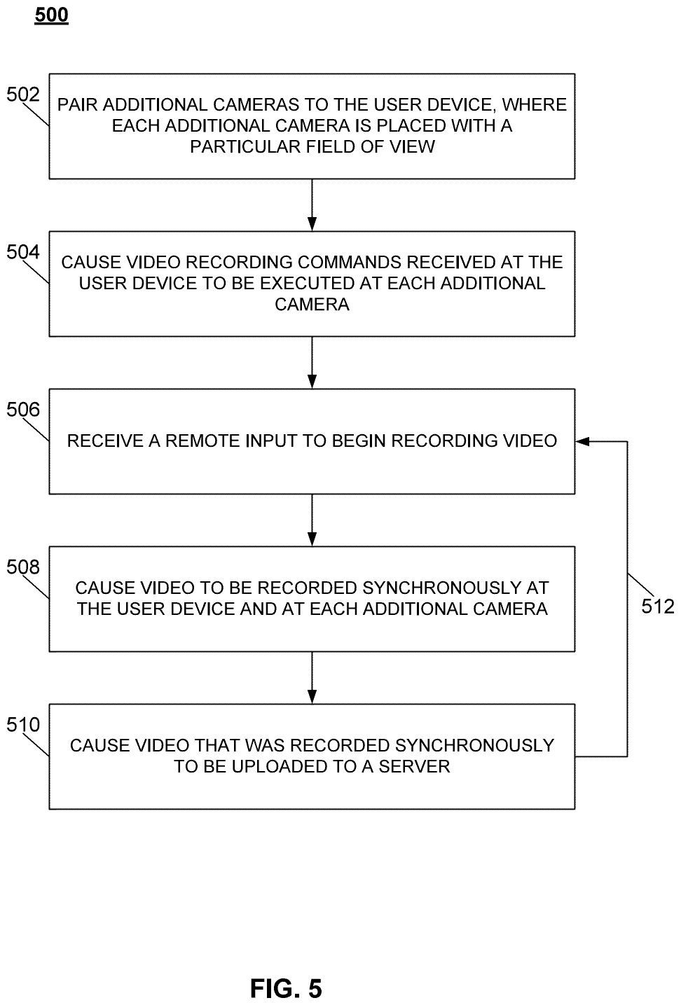

In some embodiments, a video recording session can include additional processes and/or tasks described, for example, in processes 400 and 500 as shown in FIGS. 4 and 5, respectively. In some embodiments, a video recording session can include accessing a server and associating the server with the video recording session. In some embodiments, a video recording session can include a user interface that can include a video playback window, a video editing pane, an audio editing pane, and/or any other suitable user interface elements. For example, in some embodiments, a user interface of the video recording session can include a list view of all video segments captured during the video recording session, and can include selectable elements to locally save and/or upload selected video segments to a server connected to the user device and associated with the video recording session. In another example, in some embodiments, a user interface of the video recording session can allow a user to select video segments for review and/or editing, such as combining video segments to make a composite video segment, delete video segments that are a bad take, and/or perform any other suitable review tasks.

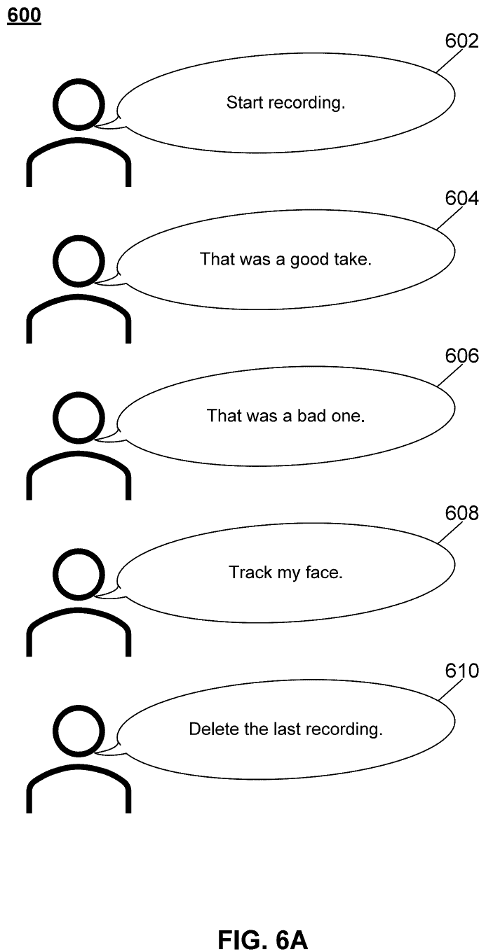

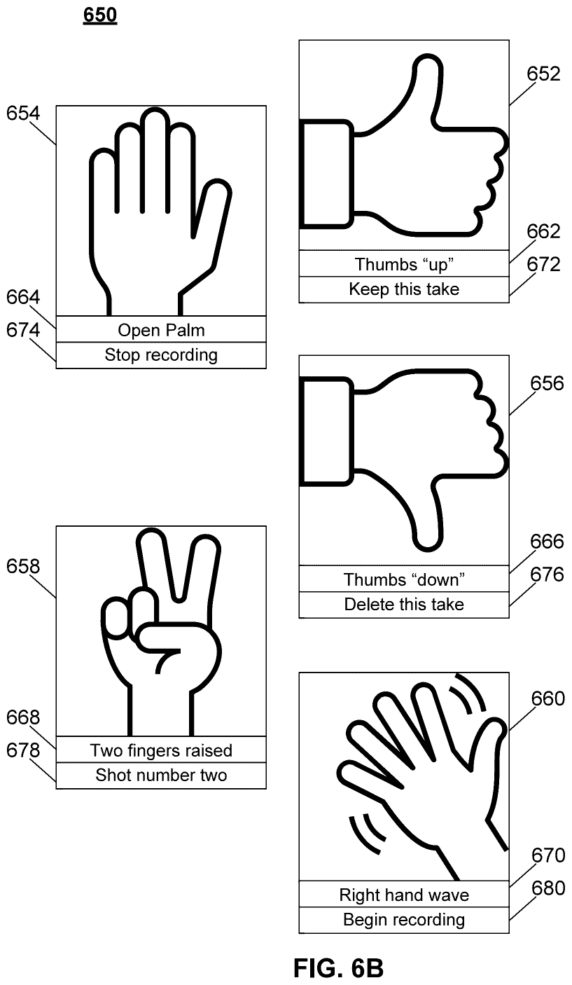

In some embodiments, process 300 can continue at 304 when process 300 receives a remote input. In some embodiments, the remote input can be a word and/or phrase (audio input), a gesture from the user to the camera (visual input), and/or a remote control input from a remote control device. In some embodiments, the remote input can be received in any suitable manner. For example, in some embodiments, the remote input can consist of a first input such as a voice input (e.g., a wake-word such as “hello phone”), followed by a second input such as a gesture. For example, as shown in example phrases 600 of FIG. 6A, any suitable phrase can be a remote input. In another example, as shown in example gestures 650 of FIG. 6B, any suitable gestures, such as a hand movement, can be a remote input. In another example, any suitable remote control device, such as an IR remote, can be used to send a remote input.

In some embodiments, at 306, process 300 can determine that a video recording command is associated with the remote input. In some embodiments, process 300 can perform any suitable analysis on the remote input to determine a video recording command associated with the remote input.

In some embodiments, at 306, when the remote input at 304 is a voice command (e.g., “hello phone, begin recording”), process 300 can perform any suitable audio analysis (e.g., natural language processing) to determine that the remote input contains the video recording command to start recording video content. For example, as shown in example phrases 600 of FIG. 6A, any suitable phrase can be a remote input and can be used at 306 to determine a video recording command.

In some embodiments, training data, such as previous audio and/or video footage recorded by the user, can be used to train process 300 on words and/or phrases that are commonly used by a particular user of process 300, and can additionally be used by process 300 to determine the video recording commands corresponding to commonly used words or phrases. For example, as shown in example phrases 600 of FIG. 6A, any suitable audio can be associated with a video recording command. As shown, example phrases 600 contains phrases 602-610, each of which can have a corresponding video command. For example, when process 300 receives the remote input contained in phrase 602 (e.g., “start recording”), process 300 can determine, at 306, a video recording command of “start recording” causes the video application executing on the user device to begin a video recording session. In another example, when process 300 receives the remote input contained in phrase 604 (e.g., “that was a good take”) and/or phrase 606 (e.g., “that was a bad one”), process 300 can determine, at 306, a video recording command to end the recording and/or to save and/or delete the recorded video segment corresponding to the remote input after ending the video recording session.

In some embodiments, at 306, when the remote input at 304 is a gesture command, process 300 can perform any suitable image and/or video analysis (e.g., object recognition, motion detection, etc.) to label the gesture and to determine a video recording command associated with the labeled gesture. For example, as shown in example gestures 650 of FIG. 6B, any suitable gesture, such as hand gestures, can be associated with a video recording command. As shown, example gestures 650 contains gestures 652-660, each having a corresponding gesture label 662-670, and an associated video recording command 672-680.

For example, in some embodiments, gesture 652 can be identified through image analysis at 306, and process 300 can associate label 662 of “thumbs up” with gesture 652, and process 300 can further determine at 306 that the associated video recording command 672 is “keep this take” 672 or otherwise cause the video application executing on the user device to store the video segment corresponding to the remote input after ending the video recording session.

In another example, in some embodiments, gesture 654 can be identified through image analysis at 306 and process 300 can associate label 664 of “open palm” with gesture 654, and process 300 can further determine at 306 that the associated video recording command is to “stop recording” 674 or otherwise cause the video application executing on the user device to stop recording the video in the video recording session.

In another example, in some embodiments, gesture 656 can be identified through image analysis at 306 and process 300 can associate label 666 of “thumbs down” with gesture 656, and process 300 can further determine at 306 that the associated video recording command is “delete this take” 676 or otherwise causing the video application executing on the user device to remove the video segment corresponding to the remote input from a storage device after ending the video recording session. Alternatively, in response to identifying gesture 656, the video application executing on the user device can place the video segment corresponding to the remote input in a queue for removal from a storage device (e.g., a local storage device on the user device, a cloud storage device associated with a user account of the user device, etc.).

In another example, in some embodiments, gesture 658 can be identified through image analysis at 306 and process 300 can associate label 668 of “Two fingers raised” with gesture 658, and process 300 can further determine at 306 that the associated that the video recording command is “Take number two” 678.

In another example, in some embodiments, gesture 660 can be identified through image analysis at 306 and process 300 can associate label 670 of “Right hand wave” with gesture 660, and process 300 can further determine at 306 that the associated that the video recording command is “Begin recording” 680.

In some embodiments, in addition to starting and ending a recording, a video recording command that is determined at 306 from a remote input can include instructions to associate any suitable metadata with the recording and/or perform additional analysis on the video recording. For example, returning to FIG. 6A, process 300 can determine, at 306, that phrase 608 (“track my face”) corresponds to a video recording command to execute object detection (e.g., face tracking) on the video data and to store and/or associate any suitable output (e.g., vectors, pixel boundaries, etc.) from the object detection with the video segment. In another example, returning to FIG. 6B, the video recording command “take number two” 678 can include instructions for process 300 to include in the metadata of the video segment that the “take number” of the video segment is equal to “two” and can additionally include other suitable information in the “take number” metadata, such as the timestamp at which gesture 658 was made. In some embodiments, process 300 can use a machine learning model at 306 to determine an association between naturally occurring words, phrases and/or gestures, and the user's desired video recording commands, such as “take number two” 678 as described above.

Note that, although voice commands and gesture commands are shown separately in FIGS. 6A and 6B, any suitable combination of voice command and gesture command can be used to identify the video recording command at 306.

In some embodiments, at 308, process 300 can cause the user device running the video recording session to execute the video recording command. For example, in some embodiments, at user device 108, a video recording command of “start recording” can cause hardware processor 202 to instruct input controller 206 to send video data and/or audio data to memory and/or storage 204, where memory and/or storage 204 then writes the video data and/or audio data to any suitable storage, such as a temporary buffer associated with the video recording session. In another example, in some embodiments, a video recording command of “keep this take” can cause hardware processor 202 to instruct memory and/or storage 204 to initiate a transfer of video data and audio data of a video recording segment from a temporary buffer to a more permanent buffer. In yet another example, in some embodiments, a video recording command of “delete this take” can cause hardware processor 202 to instruct memory and/or storage 204 to overwrite video data and audio data of the video recording segment in a buffer, effectively erasing data previously stored in said buffer. Alternatively, in some embodiments, a video recording command of “delete this take” can cause hardware processor 202 to add an indication in the metadata of the video segment data that a deletion operation is to be performed (either automatically or with user confirmation) at a later time.

As noted above at 306 for video recording commands associated with metadata, any suitable additional instructions can be executed at 308, such as for hardware processor 202 to execute object detection and/or facial tracking on video data received from input controller 206.

Additionally, in some embodiments, process 300 can cause the user device to output any suitable audible or visual cue to indicate to the user that the video recording command has been executed and/or is in the process of being executed. For example, in some embodiments, once process 300 begins recording video footage, process 300 can cause a short burst of light from the user device, e.g., using the flashlight. In another example, in some embodiments, process 300 can cause a speaker to output an automated voice with a video-start countdown, such as, “three, two, one, live”.

In some embodiments, at 310, process 300 can loop and can receive another remote input at 304. In some embodiments, process 300 can loop at 310 at any suitable frequency and for any suitable duration. For example, process 300 can loop until a user closes the application which executes process 300.

Turning to FIG. 4, an illustrative process for providing automated assistance during a video recording session is shown in accordance with some embodiments. In some embodiments, process 400 can be executed by user device 108. In some embodiments, process 400 can be executed while user device 108 is executing process 300. For example, process 400 can begin when process 300 determines a video recording command to pair additional devices at 306, as described above in connection with FIG. 3.

In some embodiments, at 402, process 400 can receive a request to pair a second user device with the video recording session started at 302 of process 300. In some embodiments, process 400 can receive the request using any suitable mechanism. For example, in some embodiments, process 400 can receive a user input such as a voice command, a gesture command, a remote control input, a keyboard input, and/or any other user input. In some embodiments, process 400 can receive the request at 402 from the second device. For example, in some embodiments, a second user device 110 can be connected to the same network as user device 108, where user device 108 is executing process 300, that is, hosting the video recording session. Continuing this example, user device 108 can send a message on the network, where the message alerts any available device that the video recording session is active, and user device 110 can respond to the message with a request to join the video recording session.

In some embodiments, at 402, process 400 can pair the second user device to the video recording session. In some embodiments, pairing an additional user device, such as user device 110, to the video recording session can allow video and audio to be sent by user device 108 to user device 110. In some embodiments, the user devices can use any suitable networking and/or communications protocol to pair the second user device to the video recording session. In some embodiments, user device 110 can perform calculations and/or make any suitable determinations regarding the video data and audio data, and user device 110 can communicate the calculations and/or determinations to user device 108. In some embodiments, process 400 can alternatively determine that a second user device is already paired to the video recording session, for example, from a previous instance of process 400 and/or any other pairing mechanism.

In some embodiments, at 404, process 400 can receive, at the first user device such as user device 108, a remote input to begin recording a video segment. In some embodiments, process 400 can receive the remote input and process it into a video recording command using techniques described above in connection with blocks 304 and 306 of process 300 described in FIG. 3.

In some embodiments, at 406, process 400 can begin recording a video segment at the first user device, such as user device 108, and can cause a live feed of the video segment to be presented on the second user device, such as user device 110. In some embodiments, process 400 can record the video segment using any suitable audio settings, video frame rate, video resolution, color balance profile, audio and/or video encoding standard(s), and/or any other suitable recording parameter. In some embodiments, process 400 can use any suitable mechanism for user device 108 to communicate the audio data and video data to user device 110. For example, in some embodiments, process 400 can send a packetized video stream using any suitable video encoding standard and/or streaming protocol (e.g., UDP, RTP, MPEG-DASH, etc.) over any suitable network, such as communication network 104.

In some embodiments, at 406, process 400 can use any suitable bitrate to send the live feed of the video segment to the second user device. For example, in some embodiments, process 400 can determine that the first user device is recording in a particular video quality (e.g., ultra-high resolution or 4K, at 120 Hz frame rate). Continuing this example, in some embodiments, process 400 can create a lower-resolution and lower-frame rate copy of the live feed (e.g., standard definition, at 60 Hz frame rate) and can send this copy to the second user device. Process 400 can, in some embodiments, create a lower resolution and lower frame rate video feed using any suitable down-sampling mechanisms (e.g., combining frames, dropping frames, re-scaling, pixel binning, dropping pixels, etc.).

In some embodiments, at 406, process 400 can additionally send the audio data of the video segment to the second user device and can cause the audio to be presented on the second user device. In some embodiments, process 400 can send the audio data at any suitable quality. In some embodiments, process 400 can alternatively send a transcription of the audio to the second user device. For example, in some embodiments, process 400 can send an audio transcript and can additionally cause the audio transcript to appear on the display concurrently with the video recording.

Continuing at 408, process 400 can apply any suitable audio analysis and image analysis techniques to the video segment while the video segment is being recorded. In some embodiments, process 400 can perform audio analysis and image analysis using the first user device hosting the video recording session. In some embodiments, process 400 can perform audio analysis and image analysis using the second user device paired with the video recording session. In some embodiments, at 408, process 400 can use any suitable mechanisms to perform audio analysis and image analysis. For example, as discussed above in connection with FIG. 2, any suitable machine learning model can use the video segment as input and can output any suitable information determined during execution of the machine learning model. In some embodiments, process 400 can use a single machine learning model to execute block 408 (audio and/or image analysis) and block 410 (determining segment metadata and segment quality metrics).

In some embodiments, at 410, process 400 can determine segment metadata and segment quality metrics for the video segment using any suitable mechanism. In some embodiments, at 410, process 400 can additionally cause any determined segment metadata and segment quality metrics to be associated with the video segment. For example, in some embodiments, process 400 can take the outputs of audio analysis at 408, which can be a transcript, and can determine segment metadata and segment quality metrics from the transcript. In another example, in some embodiments, process 400 can take the outputs of image analysis at 408, which can be a list of objects identified in a frame of video, and can determine which, if any, of the identified objects relate or contribute to the segment metadata and segment quality metrics.

In some embodiments, segment metadata can include information such as: the location of the video shoot, which can be GPS coordinates determined from location information on the user device, and/or a studio identifier (e.g., “Studio A,” “kitchen studio,” etc.) that can be identified using image and/or video data; the name of the video project; the name and/or number of the scene and/or shot and/or take; the beginning and ending timestamps and/or local clock time(s) of the segment; the time zone; the duration of the segment; the file size of the segment; information on the device hardware and/or settings used to capture the video, such as device type, camera settings, video resolution, video frame rate, color balance, video encoding standard, and/or any other suitable information. For example, in some embodiments, at 408, audio analysis can result in a transcript and, at 410, process 400 can determine (e.g., using natural language processing) that word pairs describing the video are present in the transcript. As a particular example, the audio and/or transcript can include phrases such as, “Welcome to today's video, where I will show you how to cook chicken pot pie”. Continuing this particular example, process 400 can determine that “cook,” “today's video,” and “I will show you” relate to a recipe presentation, and that the name of the video and/or video segment can be “chicken pot pie recipe.” In this particular example, process 400 can create an indication in the segment metadata, for example using an entry such as “video title,” and can store the text “chicken pot pie recipe” as the video title.

In some embodiments, segment metadata can also include a classification of the type(s) of content included in the video segment (e.g., “vegetable chopping,” “food preparation,” “cooking,” etc.). In some embodiments, classification types can relate to what a user is doing on-screen. For example, in a recorded segment that includes multiple takes of the same video content, the user can appear in the recording performing tasks not related to the rest of the video content, such as re-setting the environment to the beginning of the scene. Continuing this example, such task-based content is not relevant to the final video content, and can be considered “down time,” which can be included as a classification type and which can be included in the segment metadata. In some embodiments, segment metadata that includes a classification can include a classification type label, a starting frame and/or timestamp, and an ending frame and/or timestamp.

In some embodiments, segment quality metrics can include information relating to the video quality, audio quality, content quality, and/or any other suitable quality type in the video segment. In some embodiments, segment quality metrics can include metrics such as: the number of words spoken; the number of stutters, pauses, and/or other verbal hesitations (e.g., the use of “hmm,”, “uh,” etc.); the number of times a user appearing on camera looked off-camera; a measure of the lighting and/or color balance in the scene; a measure of amount of eye contact with the camera; a set of coordinates and/or vectors that are used for tracking eye movements and/or facial expressions, a set of coordinates and/or vectors that are used to track hand movements and/or gestures; a measure of audio quality during the segment; an indication (e.g., timestamp and/or frame number) of a particular sentiment included in the audio and/or image of the video segment (e.g., phrases such as “that was great” indicating a positive sentiment, facial expressions indicating a bad take, etc.); a measure of the user's overall confidence and/or any other suitable overall emotion during the segment; and/or any other suitable quality metric.

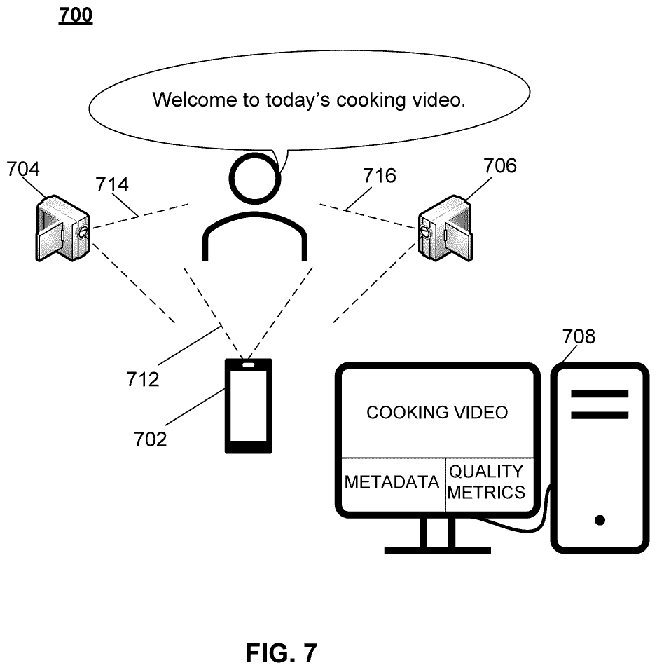

In some embodiments, at 412, process 400 can cause segment metadata and/or segment quality metrics to be displayed on the second user device during the video recording. For example, as shown in the display screen of device 708 of FIG. 7, video content can be displayed in an upper portion of the display screen, while the lower portion of the display screen can be used to display segment metadata and segment quality metrics.

In some embodiments, process 400 can cause the display of segment metadata and/or segment quality metrics using any suitable mechanism. For example, in some embodiments, the user device hosting the video recording session, such as user device 108, can determine the segment metadata and segment quality metrics at 410, and at 412, process 400 can cause user device 108 to send the segment metadata and segment quality metrics to the second user device, such as user device 110, in a separate and/or the same bitstream as the video segment bitstream. In another example, in some embodiments, user device 110 can perform the audio and image analysis at 408, and can also determine the segment metadata and segment quality metrics at 410. Continuing this example, at 412, process 400 can cause user device 110 to present the segment metadata and segment quality metrics on a display of user device 110.

In some embodiments, at 414, process 400 can loop to block 408. In some embodiments, process 400 can perform the analysis and determinations described in blocks 408 and 410 on a new portion of the recorded video segment, such as the most recent one second of footage, and/or on the total duration of the video segment including the new portion of the recording. For example, some segment metadata and/or segment quality metrics can be updated continuously and can reflect the entire duration of video footage (e.g., total words spoken in the segment, words per minute, etc.). In another example, some segment metadata and/or segment quality metrics can be applied to smaller portions of the video segment, such as determining a current background noise level for a given one second portion of the video segment. In some embodiments, process 400 can update the display of segment metadata and segment quality metrics to the most recently determined values. In some embodiments, process 400 can end at any suitable time, for example, when a user ends a recording segment. In some embodiments, process 400 can continue to execute any remaining blocks of process 400 after a user ends a recording segment. In some embodiments, any additional devices that were paired to the first user device and/or the video recording session during execution of process 400 can remain paired to the user device and/or video recording session when process 400 ends.

Turning to FIG. 5, a process for providing automated assistance during a video recording session is shown in accordance with some embodiments. In some embodiments, process 500 can be executed by user device 108. In some embodiments, process 500 can be executed while user device 108 is executing process 300. For example, process 500 can begin when process 300 determines a video recording command to pair additional devices at 306, as described above in connection with FIG. 3.

In some embodiments, at 502, process 500 can receive a request to pair one or more additional user devices with the video recording session started at 302 of process 300. In some embodiments, process 500 can receive the request using any suitable mechanism. For example, in some embodiments, process 500 can receive a user input such as a voice command, a gesture command, a remote control input, a keyboard input, and/or any other user input. In some embodiments, process 500 can use any suitable discovery technique to scan for additional user devices to pair with the video recording session. For example, in some embodiments, a second user device 110 can be connected to the same network, such as network 104, as user device 108, where user device 108 is executing process 300, that is, hosting the video recording session. Continuing this example, user device 108 can send a message on network 104 using communication links 112, where the message alerts any available device that the video recording session is active, and user device 110 can respond to the message with a request to join the video recording session.

In some embodiments, at 502, process 500 can pair the one or more additional user devices to the video recording session. In some embodiments, pairing an additional user device, such as user device 110, to the video recording session hosted by a first user device such as user device 108, can allow video and/or audio to be sent by user device 108 to user device 110. In some embodiments, pairing an additional user device, such as user device 110, to the video recording session can allow video and/or audio to be sent from user device 110 to user device 108. In some embodiments, at 502, any suitable settings and/or video recording profiles can be communicated to the one or more additional user devices. For example, in some embodiments, at 502, process 500 can determine a series of video recording settings configured for a camera and/or microphone on user device 108, such as video resolution, aspect resolution, capture frame rate, color balance settings, video encoding standard(s), microphone sensitivity, audio codec, and/or any other suitable setting. Continuing this example, in some embodiments, process 500 can determine, for each additional device, an equivalent configuration profile, list of settings and/or equivalent values of each of the settings determined in the configuration profile for the camera and microphone in user device 108. In some embodiments, process 500 can cause each of the additional user devices to have the closest configuration of video recording settings as the settings in user device 108. As a numeric example, user device 108 can have a native recording resolution of 1440p, or “Quad HD” which as an aspect ratio of 16.9, and process 500 can determine that an additional user device 110 is not capable of recording at a resolution of 1440p but can record video at a resolution of 1080p, or “Full HD”, which also has an aspect ratio of 16:9. Continuing this example, at 502, process 500 can cause the additional user device 110 to have the setting(s) that can result in video capture at user device 110 having a resolution of 1080p. In some embodiments, a user can manually configure a settings profile for an additional user device, and at 502, process 500 can cause the additional user device to have the settings stored in the manually configured profile.

In some embodiments, process 500 can alternatively determine that additional user devices are already paired to the video recording session, for example, from a previous instance of process 500 and/or any other pairing mechanism.

In some embodiments, at 504, process 500 can cause video recording commands received at the user device to be executed at each of the one or more additional user devices. For example, in some embodiments, process 500 can include instructions that when a video recording command is determined at block 306 of process 300, the video recording command is communicated to the additional user devices. In some embodiments, at 504, process 500 can perform any suitable alteration to the video recording command received at the user device in order for the video recording command to be executed on an additional user device. For example, in some embodiments, user device 108 can have a first operating system and/or generation of hardware, and user device 110 can have a second operating system and/or different generation of hardware. In this example, in some embodiments, a command determined at 306 by user device 108 can be adjusted for compatibility with the second operating system and/or different generation of hardware used in user device 110 before being communicated to user device 110.

Additionally or alternatively to additional user devices, process 500 can determine the capabilities of the user device and determine whether the user device is capable of different recording services. For example, in response to determining that the user device has multiple camera lenses (e.g., different lenses each having a different level of optical zoom, different lenses each having a different field of view, etc.), process 500 can cause the video recording session to include video content recorded from multiple lenses simultaneously, such that different video segments having different levels of optical zoom and/or different fields of view can be recorded.

In some embodiments, at 506, process 500 can receive a remote input at the first user device which is hosting the video recording session (e.g., user device 108) to begin recording video. In some embodiments, at 506, process 500 can receive the remote input and process the remote input into a video recording command using techniques described above in connection with blocks 304 and 306 of process 300 described in FIG. 3.

In some embodiments, at 508, process 500 can cause video to be recorded synchronously at the user device and at each additional user device. In some embodiments, process 500 can cause each user device paired to the video recording session to be synchronized to the same clock value, for example, by using a network time protocol. In some embodiments, process 500 can send a command to each user device to begin recording video and/or audio, and to store the video and/or audio data in a temporary storage location at the individual user device. In some embodiments, process 500 can include instructions to add any suitable information, such as device information, clock offset, etc., into the metadata for the local recordings. In some embodiments, a video segment recorded synchronously by N user devices can result in N copies of video footage with the same starting time and duration. Each copy of the video footage can, in some embodiments, consist of a different camera angle on the same scene, as can be seen in video recording session 700 of FIG. 7.

In some embodiments, at 510, process 500 can cause video that is recorded synchronously to be uploaded to a server. For example, in some embodiments, process 500 can instruct user devices to send a packetized video stream using any suitable video encoding standard and/or streaming protocol (e.g., UDP, RTP, MPEG-DASH, etc.) to a server, such as server 102. In some embodiments, user devices can use any suitable bitrate at 510 to upload video to the server. In some embodiments, process 500 can instruct a server receiving the video upload(s) to associate the individual video footage in a video container such that the video footage remains synchronized, e.g., for later retrieval, viewing, and/or editing by a user. In this manner, the individual camera angles can be simultaneously through a single playback of video footage.

In some embodiments, at 512, process 500 can loop to block 506. In some embodiments, process 500 can end at any suitable time, for example, when a user ends a recording segment. In some embodiments, process 500 can continue to execute any remaining blocks of process 500, such as uploading video recorded from additional user devices to a server, after a user ends a recording segment. In some embodiments, any additional devices that were paired to the first user device and/or the video recording session during execution of process 500 can remain paired to the user device and/or video recording session when process 500 ends.

Turning to FIG. 7, an example of a video recording session 700 using automated assistance in accordance with some embodiments of the disclosed subject matter is shown. As illustrated, video recording session 700 can include, in some embodiments, user devices 702-706 that can be used to capture audio and video, and user device 708 which can be used to display video segments during a video recording, and/or video segment metadata and/or segment quality metrics. In some embodiments, user devices 702-708 can be any suitable user devices, such as user devices 106 as discussed above in connection with FIG. 1. In some embodiments, user device 702 can be hosting the video recording session, and user devices 704-708 can be paired with user device 702 as described above in processes 400 and 500 in FIGS. 4 and 5, respectively.

As shown, each user device 702, 704 and 706 can have a field of view 712, 714, and 716, respectively. In some embodiments, as discussed in process 500 of FIG. 5 above, user devices 704 and 706 can be paired with user device 702 and can receive commands to record video synchronously with user device 702. In some embodiments, as discussed in process 400 of FIG. 4 above, user device 708 can be paired with user device 702 and can receive video data, segment metadata, and/or segment quality metrics and can display any received data, as shown in FIG. 7.

In some embodiments, recorded video segments from user devices 702-706 can be combined to create composite video using any suitable mechanism. In some embodiments, user device 702 can use a first video segment recorded at user device 702 and a second video segment recorded at user device 704 to create composite video. For example, in some embodiments, user device 702 can combine a frame of video acquired from field-of-view 712 and a frame of video acquired from field-of-view 714 to create a composite image that has a field of view wider than each of the fields of view 712 and 714. Continuing this example, user device 702 can continue in this manner and combine each synchronized frame to create a wide field-of-view video segment.

In some embodiments, user device 702 can use video segments recorded at user devices 702, 704, and 706 to track any suitable objects in a scene encompassed by fields of view 712-716. For example, in some embodiments, user device 702 can perform face tracking by using frames from a video segment having three copies of video footage resulting from synchronous recording at user devices 702, 704, and 706, as described above in block 508 of process 500. In this example, user device 702 can analyze frames from each of the copies of video footage, and can determine which frames to use in a composite video such that a user is centered at all frames of the composite video, where the composite video segment is of the same duration as the recorded video segment.

Continuing this example, user device 702 can determine that, for the first ten frames of video recorded, the user appears centered in footage recorded at user device 704. Then, in some embodiments, user device 702 can determine that in the next ten frames, the user appears centered in footage recorded at user device 702, and that for the remaining duration of the video segment, the user appears centered in the footage recorded at user device 706. In this example, user device 702 can create a new video segment where the first ten frames of the new segment are the first ten frames from user device 704, the next ten frames of the new segment correspond to the frames from user device 702, and the remaining duration of the new video segment uses footage from user device 706. In some embodiments, user device 702 can track multiple objects, such as multiple users appearing on camera, in a similar manner.

In some embodiments, user device 702 can perform object tracking automatically, and/or through a user interface that displays all available recorded video segments (e.g., all copies of video footage recorded synchronously) and allows a user to select individual sections (e.g., frames, series of frames, etc.) of a video segment to be combined.

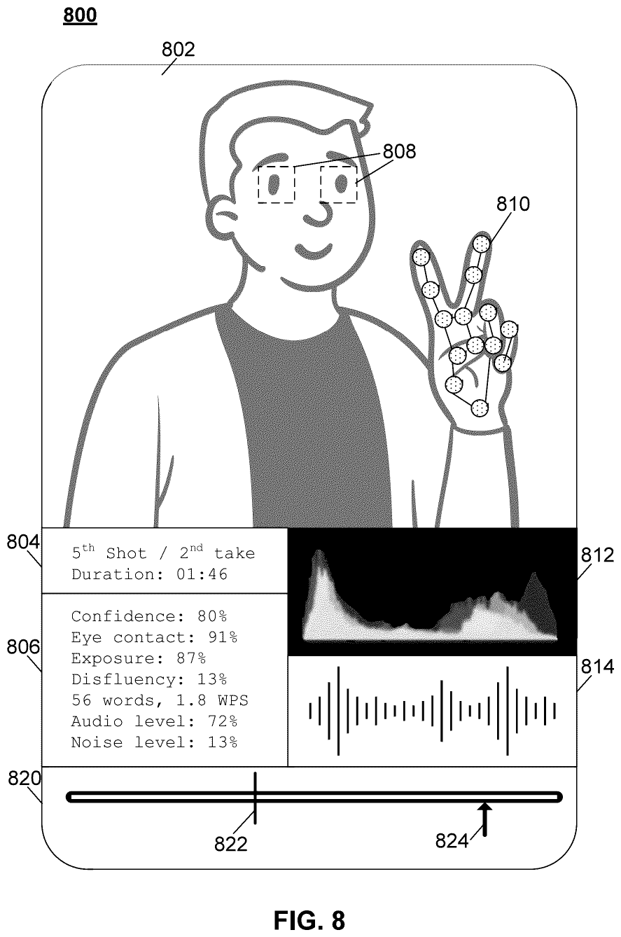

Turning to FIG. 8, an example of a display screen 800 used for providing automated assistance during a video recording session in accordance with some embodiments of the disclosed subject matter is shown. As illustrated, in some embodiments, display screen 800 includes video content 802, segment metadata 804, segment quality metrics 806-814, and timeline 820. In some embodiments, display screen 800 can include any additional elements, such as selectable user interface elements. In some embodiments, display screen 800 can be shown on a user device, such as user device 108 and/or user device 110, in combination with process 400 described in FIG. 4 above. In particular, display screen 800 can be shown on a second display screen at block 412 of process 400 in some embodiments.

As shown in FIG. 8, video content 802 can be any suitable video content included in a video recording session. In some embodiments, video content 802 can be a live video feed. In some embodiments, video 802 can be a playback of a previously recorded video segment, such as a video segment recorded during the video recording session of process 300.

Segment metadata 804 can be any suitable information, such as the video title, scene number, take number, total video duration, etc., such as segment metadata determined at block 410 of process 400 described above in connection with FIG. 4.

Segment quality metrics 806-814 can be any suitable information, data, and/or metrics, such as segment quality metrics determined at block 410 of process 400 described above in connection with FIG. 4. As shown, in some embodiments, segment quality metrics include measurements 806, eye tracking 808, gesture recognition 810, color quality display 812, and audio sample 814. In some embodiments, measurements 806 can be any suitable measurements, such as the categories (with determined values in parentheses) illustrated, including: “Confidence” (80%), “Eye contact” (91%), “Exposure” (87%), “Disfluency” (13%), word count (56 words), word speed (1.8 WPS), audio level (72%), noise level (13%). In some embodiments, eye tracking 808 and gesture recognition 810 can include a graphic overlay on video content 802, wherein any suitable mechanism can be used to determine the coordinates of the overlay. In some embodiments, color quality 812 can display color balance information (e.g., across red, green, and blue channels) for colors measured in video content 802. In some embodiments, color quality 812 can use any suitable color space and/or color system. In some embodiments, audio sample 814 can include any suitable audio waveforms, for example, speech isolated from background noise for a person speaking in video content 802.

In some embodiments, timeline 820 can be used as a navigational element for video content 802. As illustrated, in some embodiments, timeline 820 can include a play head 822 that can show the current playback time corresponding to displayed video content 802. In some embodiments, flags can be displayed in timeline 820, such as flag 824. In some embodiments, flag 824 can indicate, for example using an entry in metadata 804, that segment quality metrics 806-814 require review from a user (e.g., based on a determination that a metric is outside of a desired range of values). For example, in some embodiments, flag 824 can be displayed when any suitable mechanism (e.g., measurements and/or calculations using color quality 812) is used to determine that the lighting conditions of the video have changed. Continuing this example, in some embodiments, flag 824 can be selectable and, when selected, can navigate to the indicated playback time. In this example, navigating to a new playback time can cause the segment metadata 804 and segment quality metrics 806-814 to be updated in display screen 800.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that at least some of the above-described blocks of processes 300, 400, and/or 500 can be executed or performed in any order or sequence not limited to the order and sequence shown in and described in connection with FIGS. 3, 4, and 5. Also, some of the above blocks of processes 300, 400, and/or 500 can be executed or performed substantially simultaneously where appropriate or in parallel to reduce latency and processing times. Additionally or alternatively, some of the above described blocks of processes 300, 400, and/or 500 can be omitted and/or performed at a later time or in another suitable manner, such as using previously recorded video footage in place of the live video feed described above in connection with FIGS. 3, 4, and 5.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for providing automated assistance during a video recording session, the method comprising:
receiving, at a first user device, user input to initiate a video recording session, wherein a video recording session comprises a plurality of segments of recorded video, wherein at least one segment of recorded video is non-contiguous with a second segment of recorded video;
executing a machine learning model on the first user device that monitors the video recording session and that analyzes audio content and video content of the recorded video to determine segment metadata and segment quality metrics for each segment of the plurality of segments of recorded video;
associating each segment of the plurality of segments of recorded video with the segment metadata and the segment quality metrics determined using the machine learning model, wherein the segment metadata and the segment quality metrics for each segment of the plurality of segments is presented when editing the recorded video from the video recording session;
receiving a remote input during the video recording session, wherein the remote input comprises at least one of a voice command, a gesture command, and a remote control command;
determining, using the machine learning model executing on the first user device, a video recording command associated with the remote input; and
causing the video recording session to execute an action associated with the video recording command.

2. The method of claim 1, wherein the method further comprises:
receiving a request to pair a second user device with the video recording session;
causing the second user device to join the video recording session by pairing the second user device with the first user device, and
causing the video segment to be displayed on the second user device concurrently with the segment metadata and the segment quality metrics, wherein the segment metadata and the segment quality metrics are updated while recording the video segment.

3. The method of claim 1, wherein at least one of the segment metadata and the segment quality metrics indicates a first timestamp and a second timestamp and further indicates that video content between the first timestamp and the second timestamp is a particular type of video content from a plurality of types of video content.

4. The method of claim 1, wherein the remote input further comprises a wake word occurring before at least one of the voice command, the gesture command, and the remote command.

5. The method of claim 1, wherein the method further comprises:
receiving a request to pair the first media device to each media device in a plurality of media devices, wherein each of the media devices comprises a video input, wherein each video input has a particular field of view;
causing each media device in the plurality of devices to join the video recording session by pairing with the first user device, wherein pairing with the first user device causes video recording determined at the first media device to additionally be executed at each of the plurality of media devices;
initiating a video recording segment in response to a first remote input received at the first media device;
recording a full scene video segment, wherein a full scene video segment comprises a plurality of video segments, wherein each video segment in the plurality of video segments is recorded synchronously at each media device, and wherein each video segment includes an indication of which media device in the plurality of media devices was used to record each video segment;
causing the video recording segment to stop being recorded in response to a second remote input received at the first media device; and
causing each media device to upload the video segment recorded at the media device to a server associated with the first media device, wherein the server combines the plurality of video segments into the full scene video segment.

6. The method of claim 5, wherein a first subset of segments in the full scene video segment are combined by the first user device to create a second field of view, wherein the second field of view is larger than each of the particular field of view for each segment used in the first subset.

7. The method of claim 5, wherein the method further comprises:
identifying, using the full scene video segment, a target object and a background;
identifying a starting frame and an ending frame from the full scene video segment, where the target object is positioned in a first portion of the background in the starting frame and in a second portion of the background in the ending frame;
determining a second subset of segments in the full scene video segment that shows the target object moving from the first portion of the background to the second portion of the background, and wherein the target object remains approximately centered in each frame of the second subset of segments; and
combining the second subset of segments into a first duration of video footage.

8. The method of claim 7, wherein the target object comprises a plurality of persons, and wherein the method further comprises:
identifying, for each person in the plurality of persons, a particular starting frame and a particular ending frame from the full scene video segment where the person is positioned in a particular first portion of the background in the starting frame and in a particular second portion of the background in the ending frame;
determining, for each person in the plurality of persons, a particular subset of segments in the full scene video segment that shows the person moving from the particular first portion of the background to the particular second portion of the background, and wherein the person remains approximately centered in each frame of the particular subset of segments; and
combining, for each person in the plurality of persons, the particular subset of segments into a particular duration of video footage.

9. A system for providing automated assistance during a video recording session, the system comprising:
a memory; and
a hardware processor that is configured to:
receive, at a first user device, user input to initiate a video recording session, wherein a video recording session comprises a plurality of segments of recorded video, wherein at least one segment of recorded video is non-contiguous with a second segment of recorded video;
execute a machine learning model on the first user device that monitors the video recording session and that analyzes audio content and video content of the recorded video to determine segment metadata and segment quality metrics for each segment of the plurality of segments of recorded video;
associate each segment of the plurality of segments of recorded video with the segment metadata and the segment quality metrics determined using the machine learning model, wherein the segment metadata and the segment quality metrics for each segment of the plurality of segments is presented when editing the recorded video from the video recording session;
receive a remote input during the video recording session, wherein the remote input comprises at least one of a voice command, a gesture command, and a remote control command;
determine, using the machine learning model executing on the first user device, a video recording command associated with the remote input; and
cause the video recording session to execute an action associated with the video recording command.

10. The system of claim 9, wherein the hardware processor is further configured to:
receive a request to pair a second user device with the video recording session;
cause the second user device to join the video recording session by pairing the second user device with the first user device; and
cause the video segment to be displayed on the second user device concurrently with the segment metadata and the segment quality metrics, wherein the segment metadata and the segment quality metrics are updated while recording the video segment.

11. The system of claim 9, wherein at least one of the segment metadata and the segment quality metrics indicates a first timestamp and a second timestamp and further indicates that video content between the first timestamp and the second timestamp is a particular type of video content from a plurality of types of video content.

12. The system of claim 9, wherein the remote input further comprises a wake word occurring before at least one of the voice command, the gesture command, and the remote command.

13. The system of claim 9, wherein the hardware processor is further configured to:
receive a request to pair the first media device to each media device in a plurality of media devices, wherein each of the media devices comprises a video input, wherein each video input has a particular field of view;
cause each media device in the plurality of devices to join the video recording session by pairing with the first user device, wherein pairing with the first user device causes video recording determined at the first media device to additionally be executed at each of the plurality of media devices;
initiate a video recording segment in response to a first remote input received at the first media device;
record a full scene video segment, wherein a full scene video segment comprises a plurality of video segments, wherein each video segment in the plurality of video segments is recorded synchronously at each media device, and wherein each video segment includes an indication of which media device in the plurality of media devices was used to record each video segment;
cause the video recording segment to stop being recorded in response to a second remote input received at the first media device; and
cause each media device to upload the video segment recorded at the media device to a server associated with the first media device, wherein the server combines the plurality of video segments into the full scene video segment.

14. The system of claim 13, wherein a first subset of segments in the full scene video segment are combined by the first user device to create a second field of view, wherein the second field of view is larger than each of the particular field of view for each segment used in the first subset.

15. The system of claim 13, wherein the hardware processor is further configured to:
identify, using the full scene video segment, a target object and a background;
identify a starting frame and an ending frame from the full scene video segment, where the target object is positioned in a first portion of the background in the starting frame and in a second portion of the background in the ending frame;
determine a second subset of segments in the full scene video segment that shows the target object moving from the first portion of the background to the second portion of the background, and wherein the target object remains approximately centered in each frame of the second subset of segments; and
combine the second subset of segments into a first duration of video footage.

16. The system of claim 15, wherein the target object comprises a plurality of persons, and wherein the hardware processor is further configured to:
identify, for each person in the plurality of persons, a particular starting frame and a particular ending frame from the full scene video segment where the person is positioned in a particular first portion of the background in the starting frame and in a particular second portion of the background in the ending frame;
determine, for each person in the plurality of persons, a particular subset of segments in the full scene video segment that shows the person moving from the particular first portion of the background to the particular second portion of the background, and wherein the person remains approximately centered in each frame of the particular subset of segments; and
combine, for each person in the plurality of persons, the particular subset of segments into a particular duration of video footage.

17. A non-transitory computer-readable medium containing computer executable instructions that, when executed by a processor, cause the processor to execute a method for providing automated assistance during a video recording session, the method comprising:
receiving, at a first user device, user input to initiate a video recording session, wherein a video recording session comprises a plurality of segments of recorded video, wherein at least one segment of recorded video is non-contiguous with a second segment of recorded video;
executing a machine learning model on the first user device that monitors the video recording session and that analyzes audio content and video content of the recorded video to determine segment metadata and segment quality metrics for each segment of the plurality of segments of recorded video;
associating each segment of the plurality of segments of recorded video with the segment metadata and the segment quality metrics determined using the machine learning model, wherein the segment metadata and the segment quality metrics for each segment of the plurality of segments is presented when editing the recorded video from the video recording session;
receiving a remote input during the video recording session, wherein the remote input comprises at least one of a voice command, a gesture command, and a remote control command;
determining, using the machine learning model executing on the first user device, a video recording command associated with the remote input; and
causing the video recording session to execute an action associated with the video recording command.

18. The non-transitory computer-readable medium of claim 17, wherein the method further comprises:
receiving a request to pair a second user device with the video recording session;
causing the second user device to join the video recording session by pairing the second user device with the first user device; and
causing the video segment to be displayed on the second user device concurrently with the segment metadata and the segment quality metrics, wherein the segment metadata and the segment quality metrics are updated while recording the video segment.

19. The non-transitory computer-readable medium of claim 17, wherein at least one of the segment metadata and the segment quality metrics indicates a first timestamp and a second timestamp and further indicates that video content between the first timestamp and the second timestamp is a particular type of video content from a plurality of types of video content.

20. The non-transitory computer-readable medium of claim 17, wherein the remote input further comprises a wake word occurring before at least one of the voice command, the gesture command, and the remote command.

21. The non-transitory computer-readable medium of claim 17, wherein the method further comprises:
receiving a request to pair the first media device to each media device in a plurality of media devices, wherein each of the media devices comprises a video input, wherein each video input has a particular field of view;
causing each media device in the plurality of devices to join the video recording session by pairing with the first user device, wherein pairing with the first user device causes video recording determined at the first media device to additionally be executed at each of the plurality of media devices;
initiating a video recording segment in response to a first remote input received at the first media device;
recording a full scene video segment, wherein a full scene video segment comprises a plurality of video segments, wherein each video segment in the plurality of video segments is recorded synchronously at each media device, and wherein each video segment includes an indication of which media device in the plurality of media devices was used to record each video segment;
causing the video recording segment to stop being recorded in response to a second remote input received at the first media device; and
causing each media device to upload the video segment recorded at the media device to a server associated with the first media device, wherein the server combines the plurality of video segments into the full scene video segment.

22. The non-transitory computer-readable medium of claim 21, wherein a first subset of segments in the full scene video segment are combined by the first user device to create a second field of view, wherein the second field of view is larger than each of the particular field of view for each segment used in the first subset.

23. The non-transitory computer-readable medium of claim 21, wherein the method further comprises:
identifying, using the full scene video segment, a target object and a background;
identifying a starting frame and an ending frame from the full scene video segment, where the target object is positioned in a first portion of the background in the starting frame and in a second portion of the background in the ending frame;
determining a second subset of segments in the full scene video segment that shows the target object moving from the first portion of the background to the second portion of the background, and wherein the target object remains approximately centered in each frame of the second subset of segments; and
combining the second subset of segments into a first duration of video footage.

24. The non-transitory computer-readable medium of claim 23, wherein the target object comprises a plurality of persons, and wherein the method further comprises:
identifying, for each person in the plurality of persons, a particular starting frame and a particular ending frame from the full scene video segment where the person is positioned in a particular first portion of the background in the starting frame and in a particular second portion of the background in the ending frame;
determining, for each person in the plurality of persons, a particular subset of segments in the full scene video segment that shows the person moving from the particular first portion of the background to the particular second portion of the background, and wherein the person remains approximately centered in each frame of the particular subset of segments; and
combining, for each person in the plurality of persons, the particular subset of segments into a particular duration of video footage.
